(19) United States
(12) Patent Application Publication
(10) Pub. No.: US 2007/0193959 A1
(43) Pub. Date: Aug. 23, 2007

(54) Drip-filter type extraction apparatus and flow rate controller thereof

(76) Inventor: Min Nin Yu, Taichung County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/707,858

(22) Filed: Feb. 20, 2007

(30) Foreign Application Priority Data
Feb. 20, 2006 (TW) 95105655

(51) Int. Cl. B01D 21/00; C02F 1/00

(52) U.S. Cl. 210/800; 210/804

(57) ABSTRACT

A drip-filter extraction apparatus comprises a container, a flow rate controller and an extraction device. The container receives a liquid therein. The flow rate controller controls the liquid in the container flowing out at a constant flow rate. The extraction device collects the liquid and mixes it with extraction material to form a mixed liquid, and then the extraction device filters and collects the mixed liquid.

### BACKGROUND OF THE INVENTION

1. Field of the Invention

The present invention relates to an extraction apparatus, and more particularly to a drip-filter type extraction apparatus and a flow rate controller thereof.

2. Description of the Related Art

In some conditions, flow rate control of liquid is very important, particularly, when it relates to a reaction processs, such as extraction processs.

For instance, a water drip extraction apparatus for making ice coffee. Many factors affect the quality of making a good ice coffee, such as coffee powder's quality, water temperature, time of ice water contacting coffee powder.

As shown in FIG. 1, a conventional ice extraction apparatus 1 includes a frame 2, on which a first container 3, a second container 4, a collection container 5, a flow rate controller 6 and a filter 7 are provided. The first container 3 is above the collection container 5 to receive ice water 8 therein. The second container 4 is between the first container 3 and the collection container 5, in which there are the filter 7 and coffee powder 9. The flow rate controller 6 is under the first container 3, which includes an adjusting member 6a to control a flow rate of ice water 8 dripping to the second container 4.

The ice water 8 is mixed with the coffee powder 9 in the second container 4 and flows through the filter 7 to the collection container 5 to have ice coffee collected in the collection container 5. The flow rate controller 6 provides a throttle valve to control the flow rate of ice water. We know that the water flow is positive proportional to both the cross-sectional area of throttle orifice and the water pressure. As a result, the flow rate controller 6 provides ice water 8 with a slower and slower flow rate to the second container 4 when ice water 8 becomes less in the first container 3. Even when the flow rate controller 6 keeps the orifice with a constant cross-sectional area, the flow rate changes and, hence, the time of ice water flowing through coffee powder changes. It affects the time of ice water 8 mixed with coffee powder 9. In other words, the quality of ice coffee is changingfrom beginning to end.

### SUMMARY OF THE INVENTION

The present invention provides a drip-filter extraction apparatus and a flow rate controller thereof, which provides liquid with a constant flow rate.

The drip-filter type extraction apparatus comprises a container, a flow rate controller and an extraction device. The container receives a liquid therein, such as ice water. The flow rate controller controls the liquid in the container flowing out at a constant flow rate. The extraction device includes a material container with an outlet at a bottom thereof for receiving an extraction material therein, a filter in the material container, and a collection container for receiving a mixed liquid. The liquid from the flow rate controller flows to the material container and is mixed with the extraction material, such as coffee powder, in the material container to form the mixed liquid, such as ice coffee, and then the mixed liquid flows to the collection container through filter and the outlet of the material container.

### BRIEF DESCRIPTION OF THE DRAWINGS

FIG. 1 is a sketch diagram of the conventional drip extraction apparatus;

FIG. 2 is a sketch diagram of a first preferred embodiment of the present invention;

FIG. 3 is a perspective view of the guiding unit of the first preferred embodiment of the present invention;

FIG. 4 is a sketch diagram of the first preferred embodiment of the present invention, showing the guiding tube being pressed downwards;

FIG. 5 is a sketch diagram of the first preferred embodiment of the present invention, showing ice water being out;

FIG. 6 and FIG. 7 are sketch diagrams of the first preferred embodiment of the present invention, showing guiding tube with changeable length;

FIG. 8 is a sketch diagram of a second preferred embodiment of the present invention; and

FIG. 9 is a sketch diagram of the second preferred embodiment of the present invention, showing the guiding tube being pressed downwards.

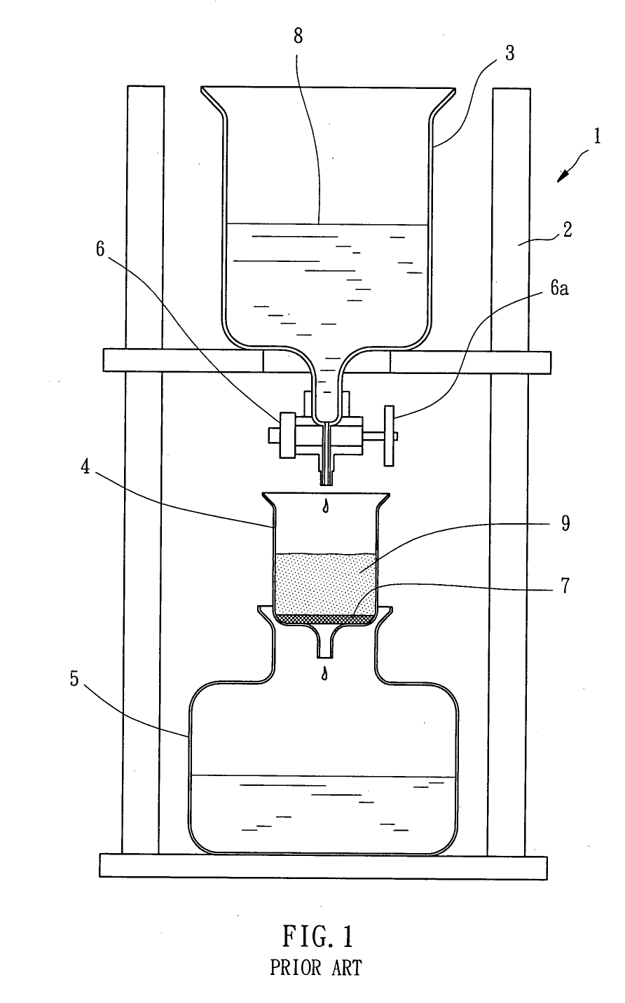

### DETAILED DESCRIPTION OF THE INVENTION

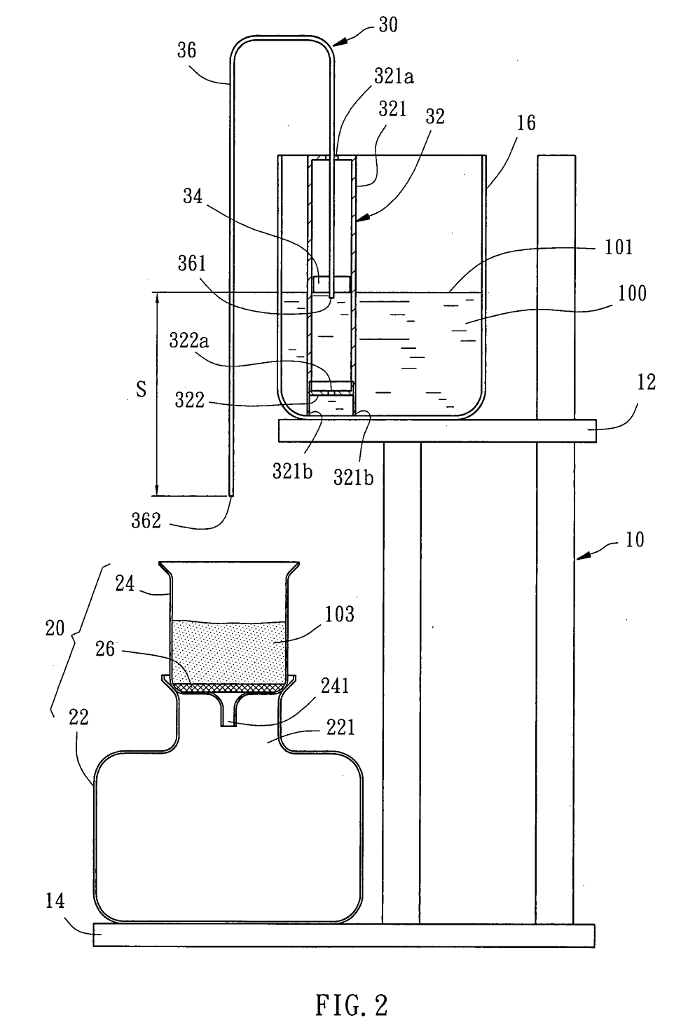

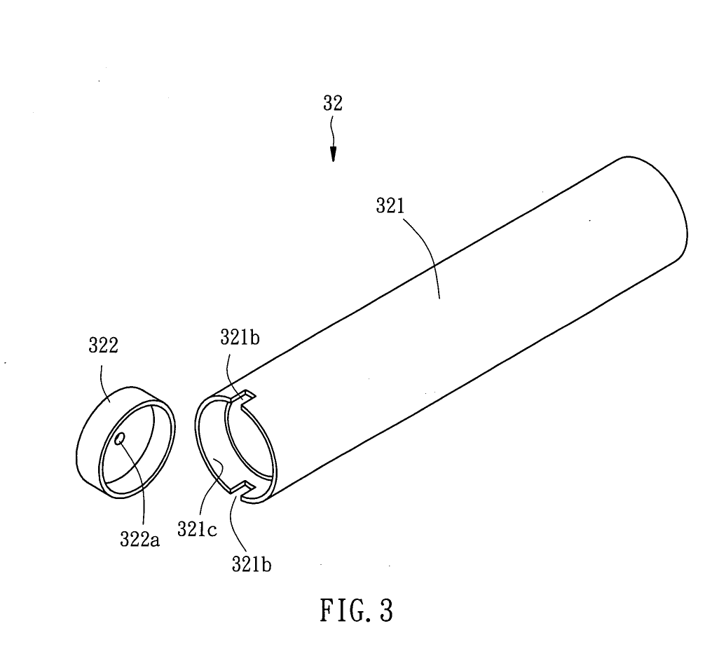

As shown in FIG. 2 and FIG. 3, a drip-filter type extraction apparatus of the preferred embodiment of the present invention for making ice coffee comprises a frame 10, a container 16, an extraction device 20 and a flow rate controller 30.

The frame 10 comprises a high stand 12 and a carrier base 14.

The container 16 is mounted on the high stand 12, in which ice water 100 or other liquid is received.

The extraction device 20 comprises a collection container 22, a material container 24 and a filter 26.

The collection container 22 is provided on the carrier base 14 under the container 16, which has an opening 221.

The material container 24 is provided above the collection container 22, which has an outlet 241 associated with the opening 221 of the collection container 22.

The filter 26 is received in the material container 24, and an extraction material 103, such as coffee powder, is received in the material container 24 above the filter 26.

The flow rate controller 30 guides the ice water 100 in the container 16 to the extraction device 20, which comprises a guiding unit 32, a floatable member 34 and a guiding tube 36.

As shown in FIG. 3, the guiding unit 32 comprises a column-like regulating tube 321 and a floatable throttle disk 322. The regulating tube 321 is received in the container 16 with an upper opening 321a higher than a level 101 of the ice water 1100 and two lower opening 321b lower tahn the level 101 of the ice water 100. The two lower opening 321b is designed to let ice water flow in whenever the floatable throttle 322 is not block them. One example is to locatethe lower opening 321b at a level lower than the thickness of the floatable throttle disk 322. The regulating tube 321 has a greater diameter portion 321c adjacent to the lower opening 321b, in which the floatable throttle disk 322 is received. The floatable throttle disk 322 has a bore 322a.

The floatable member 34 is received in the regulating tube 321 and floated on the level 101 of the ice water 100.

The guiding tube 36 is fixed to the floatable member 34, which comprises an inlet 361 at an end thereof and an outlet 362 at the other end thereof. The guiding tube 36 has the end with the inlet 361 passing through the upper opening 321a of the regulating tube 321 and the floatable member 34 to have the inlet 361 under the level 101 and the outlet 362 left out of the container 16 and under the level 101 for a predetermined depth S. Whenever the guiding tube 26 is not deformable, the depth S is constant.

Above is the structure of the extraction apparatus of the present invention, and the operation of the extraction apparatus will be described hereunder.

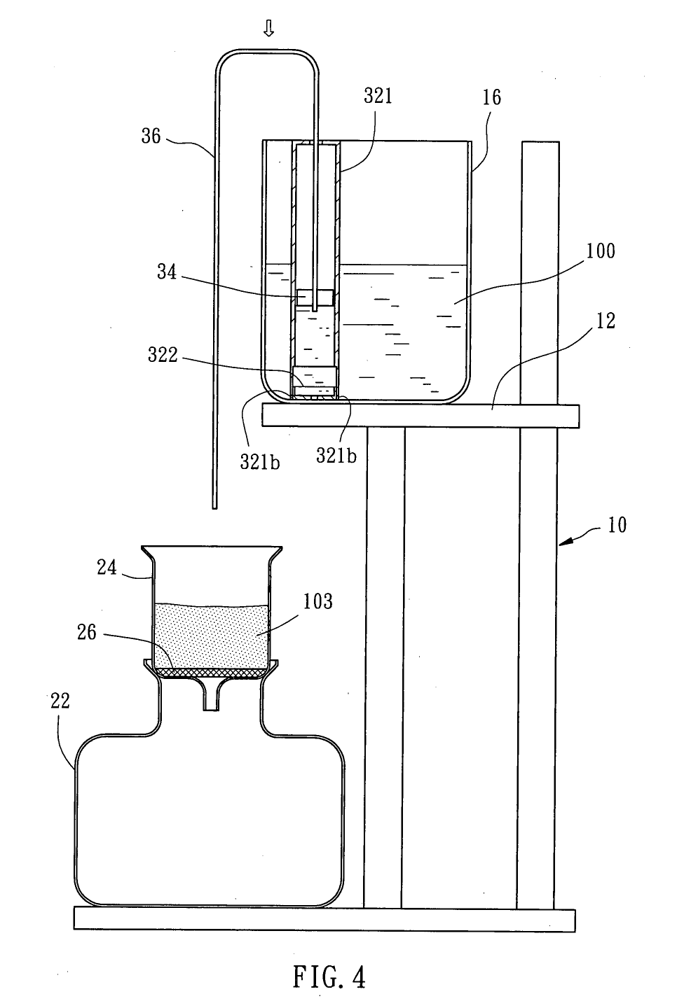

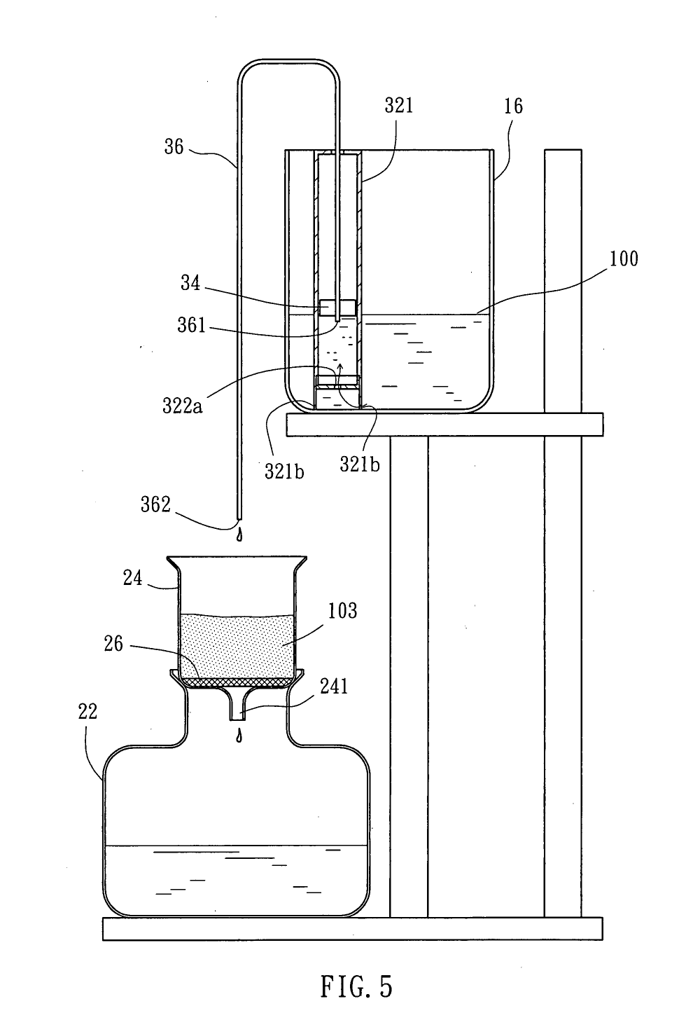

As shown in FIG. 2, the ice water 100 is received in the container 16 and does not flow toward the extraction device 20 via the guiding tube 36 yet. As shown in FIG. 4, when the guiding tube 36 is pressed downwards, the floatable member 34 is moved downwards, too. Therefore, the pressure in the regulating tube 321 raises up and moves the floatable throttle disk 322 downwards to the bottom of the container 16. Then, the lower opening 321b and the bore 322b are sealed. The pressure in the regulating tube 321 raises higher while the guiding tube 36 is being pressed downwards, and water will be forced to flow into the guiding tube 36 via the inlet 361 and flow out via the outlet 362 to balance the pressure. Next, when the guiding tube 36 is released, as shown in FIG. 5, the ice water 100 outside of the regulating tube 321 flows into the regulating tube 321 through the lower opening 321b and bore 322a of the floatable throttle disk 322 until water level in the regulating tube 321 raises to the level of the ice water 200 outside. Therefore, the guiding tube 36 is filled with water and the outlet 362 is lower than the water level that siphon effect occurres to pump the ice water 100 in the guiding tube 36 out of the container 16 and drip the ice water 100 into the material container 24 of the extraction device 20. The ice water 100 then mixes with the extraction material 103. It has to be mentioned that the floatable member 34 and the guiding tube 36 move along with the level of the ice water, and the outlet 362 of the guiding tube 36 always keeps at a constant depth S under the level 101 so that the ice water 100 always flows with a constant flow rate without being affected by the water level change. The present invention provides the liquid with constant flow rate that is good for the condition when time is important in reaction of liquid. For example, in making ice coffee, the present invention makes a steady quality ice coffee from the beginning throughout to the end.

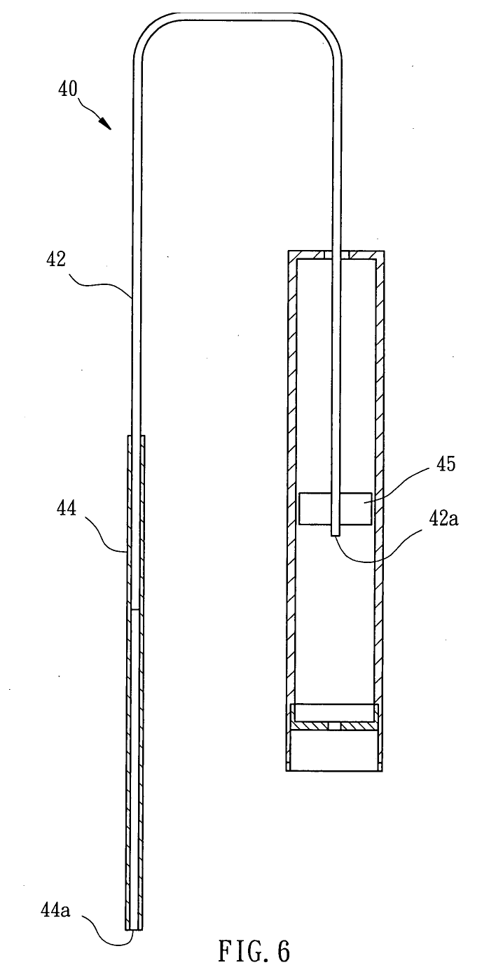

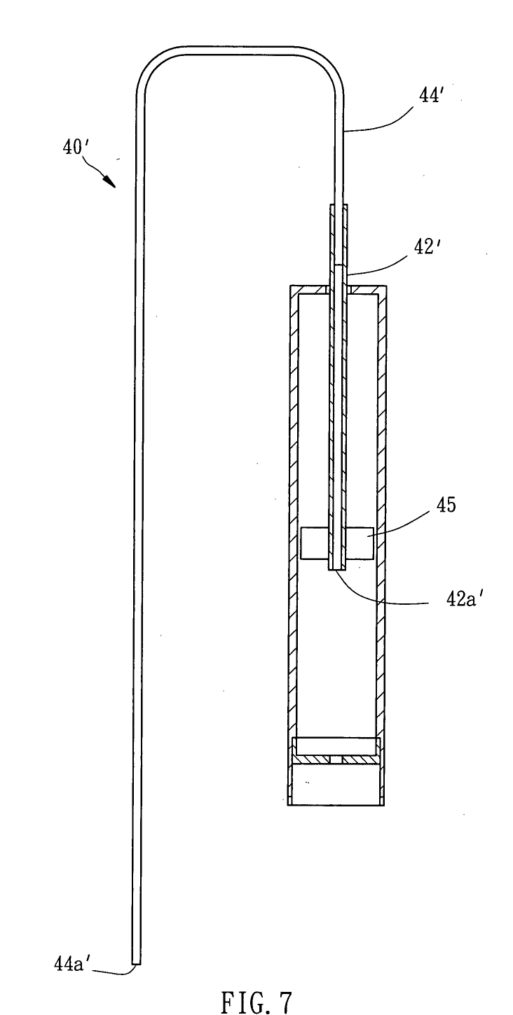

The guiding tube of the present invention may be a retractable member to meet various requirements. As shown in FIG. 6 and FIG. 7, guiding tubes 40 and 40′ consist of a first tube 42 and 42′ and a second tube 44 and 44′. The first tube 42 and 42′ and the second tube 44 and 44′ are fitted to or screwed to each other. The first tube 42 and 42′ passes through a floatable member 45 and has an inlet 42a and 42a′. The second tube 44 and 44′ extends out of a container (not shown) and has an outlet 44a and 44′a.

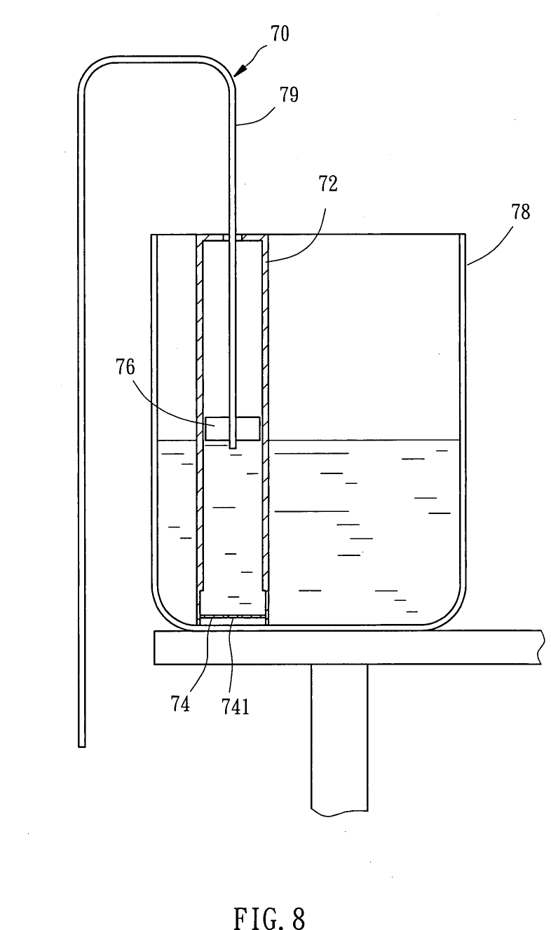

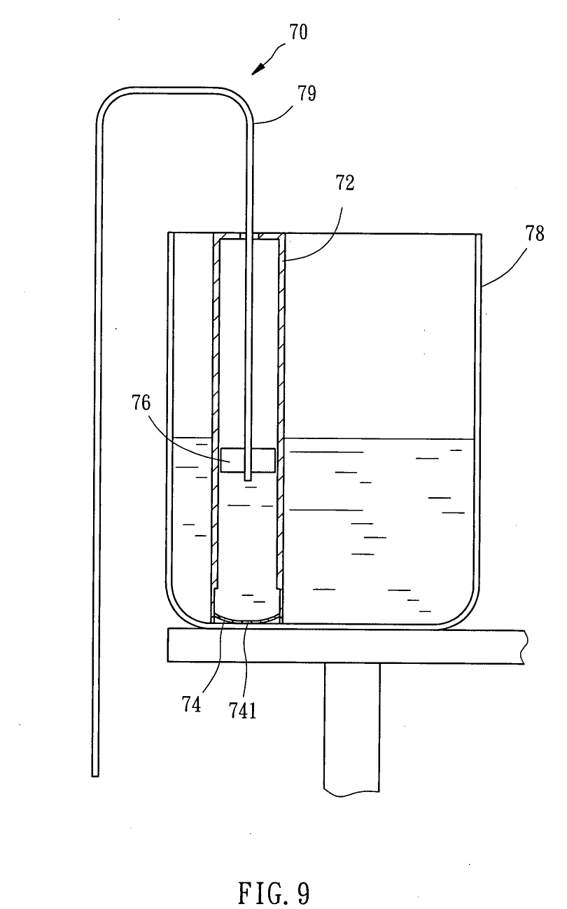

FIG. 8 shows another guiding unit 70, which has a column-like tube 72 with a film 74 therein to replace the throttle disk. The film 74, which is fixed to an interior wall of the tube 72, has an aperture 741 at a center thereof. The film 74 keeps horizontal for passing through liquid when a floatable member 76 is not pressed downwards. FIG. 9 shows the film 74 being pressed for deformation, in which the aperture 741 is sealed by bottom of a container 78. Therefore, when the floatable member 76 keeps being pressed, it forces liquid entering a guiding tube 79 and siphon effect occurs when the pressing force is out.

The description above is a preferred embodiment of the present invention and the equivalence of the present invention is still in the scope of the claim of the present invention.

What is claimed is:

1. A drip-filter type extraction apparatus, comprising:
a container for receiving a liquid therein;
a flow rate controller for controlling the liquid in the container flowing out at a constant flow rate; and
an extraction device comprising a material container having an outlet at a bottom thereof for receiving an extraction material therein, a filter in the material container, and a collection container for receiving a mixed liquid;
wherein the liquid from the flow rate controller flows to the material container and is mixed with the extraction material in the material container to form the mixed liquid, and then the mixed liquid flows to the collection container through filter and the outlet of the material container.

2. The drip-filter type extraction apparatus as defined in claim 1, wherein the flow rate controller comprises a floatable member floating on a level of the liquid, a guiding tube, which is connected to the floatable member, having an inlet located in the container and an outlet located outside of the container and under the level of the liquid at a depth (S).

3. The drip-filter type extraction apparatus as defined in claim 2, wherein the flow rate controller further comprises a regulating tube, which is located in the container and receives the floatable member therein, having an upper opening above the level of the liquid to pass the guiding tube therethrough and at least a lower opening under the level of the liquid.

4. The drip-filter type extraction apparatus as defined in claim 3, wherein the flow rate controller further comprises a throttle disk having a bore, and the regulating tube has a greater diameter portion adjacent to a bottom end thereof and associated with the lower opening to receive the throttle disk therein.

5. The drip-filter type extraction apparatus as defined in claim 2, wherein the guiding tube has a first tube passing through the floatable member and having the inlet thereon and a second tube extending out of the container and having the outlet thereon.

6. The drip-filter type extraction apparatus as defined in claim 5, wherein the first tube is connected to the second tube in a retractable condition to change a distance between the level of the liquid and the outlet.

7. A flow rate controller used in guiding liquid from a higher level to a lower level, comprising:
a container for receiving a liquid;
a floatable member floated on a level of the liquid and moved along with the level of the liquid;
a guiding tube, which is connected to the floatable member to move along with the floatable member, comprising an inlet located in the container and an outlet located outside of the container and under the level of the liquid at a depth (S); and
a guiding unit for guiding the liquid in the container flowing out of the container through the guiding tube.

8. The flow rate controller as defined in claim 7, wherein the guiding unit comprises a regulating tube, which is in the container and receives the floatable member therein, having an upper opening above the level of the liquid to pass the guiding tube therethrough and at least a lower opening under the level of the liquid.

9. The flow rate controller as defined in claim 8, wherein the guiding unit further comprises a throttle disk with a bore, and the regulating tube has a greater diameter portion adjacent to a bottom end thereof and associated with the lower opening to receive the throttle disk therein.

10. The flow rate controller as defined in claim 7, wherein the guiding tube comprises a first tube passing through the floatable member and having the inlet thereon and a second tube extending out of the container and having the outlet thereon.

11. The flow rate controller as defined in claim 10, wherein the first tube is connected to the second tube in a retractable condition to change a distance between the level of the liquid and the outlet.
